(19) United States
(12) Patent Application Publication
(10) Pub. No.: US 2026/0230322 A1
(43) Pub. Date: Aug. 6, 2026

(54) PROVIDING VIRTUAL IDENTIFIERS, WITH EXPIRY PARAMETERS, TO MOBILE DEVICES

(71) Applicant: Capital One Services, LLC, McLean, VA (US)

(72) Inventor: Anisha BELADIA, Manassas Park, VA (US)

(21) Appl. No.: 19/044,031

(22) Filed: Feb. 3, 2025

(51) Int. Cl. H04L 9/32; H04L 9/40

(52) U.S. Cl. CPC H04L 9/3213; H04L 63/0407; H04L 63/102

(57) ABSTRACT

In some implementations, a mobile device may receive, from an identifier manager, a token encoding the virtual identifier and an indication of the expiry parameter to associate with the token. The mobile device may output a user interface (UI) including a graphical representation of the token. The mobile device may determine, based on the expiry parameter, that the token has expired. The mobile device may modify the UI to hide the graphical representation of the token in response to determining that the token has expired.

### BACKGROUND

To improve security in a computerized system, virtual identifiers may be used in place of permanent identifiers. For example, a virtual card number (VCN) may be used in place of a payment account number (PAN). Tokenizing the PAN into the VCN improves security because the VCN may be replaced, if compromised, more easily than the PAN.

### SUMMARY

Some implementations described herein relate to a system for providing a virtual identifier. The system may include one or more memories and one or more processors communicatively coupled to the one or more memories. The one or more processors may be configured to receive, from a user device, a request for the virtual identifier, the request indicating an intended user for the virtual identifier and a permanent identifier to be associated with the virtual identifier. The one or more processors may be configured to receive, from the user device, an indication of the expiry parameter for the virtual identifier. The one or more processors may be configured to generate the virtual identifier in response to the request. The one or more processors may be configured to transmit, to an account manager, the virtual identifier for association with the permanent identifier and the expiry parameter. The one or more processors may be configured to determine the mobile receiving device based on the intended user. The one or more processors may be configured to transmit, to an application executed by the mobile receiving device, a token encoding the virtual identifier. The one or more processors may be configured to transmit, to the application executed by the mobile receiving device, an indication of the expiry parameter to associate with the token.

Some implementations described herein relate to a method of receiving a virtual identifier. The method may include receiving, at a mobile device and from an identifier manager, a token encoding the virtual identifier and an indication of the expiry parameter to associate with the token. The method may include outputting, by the mobile device, a user interface (UI) including a graphical representation of the token. The method may include determining, by the mobile device and based on the expiry parameter, that the token has expired. The method may include modifying, by the mobile device, the UI to hide the graphical representation of the token in response to determining that the token has expired.

Some implementations described herein relate to a non-transitory computer-readable medium that stores a set of instructions for receiving a virtual identifier with an expiry parameter. The set of instructions, when executed by one or more processors of a device, may cause the device to receive, from an identifier manager, a token encoding the virtual identifier and an indication of the expiry parameter to associate with the token. The set of instructions, when executed by one or more processors of the device, may cause the device to output a UI including a graphical representation of the token, wherein the graphical representation is distinguished from at least one additional graphical representation of at least one non-virtual identifier. The set of instructions, when executed by one or more processors of the device, may cause the device to receive an indication of an interaction with the graphical representation of the token. The set of instructions, when executed by one or more processors of the device, may cause the device to update the UI, in response to the indication of the interaction, to indicate the expiry parameter.

### BRIEF DESCRIPTION OF THE DRAWINGS

FIGS. 1A-1E are diagrams of an example implementation relating to providing virtual identifiers, with expiry parameters, to mobile devices, in accordance with some embodiments of the present disclosure.

FIGS. 2A-2F are diagrams of example user interfaces associated with indicating a virtual identifier, in accordance with some embodiments of the present disclosure.

FIG. 3 is a diagram of an example environment in which systems and/or methods described herein may be implemented, in accordance with some embodiments of the present disclosure.

FIG. 4 is a diagram of example components of one or more devices of FIG. 3, in accordance with some embodiments of the present disclosure.

FIGS. 5-6 are flowcharts of example processes relating to receiving virtual identifiers with expiry parameters, in accordance with some embodiments of the present disclosure.

### DETAILED DESCRIPTION

The following detailed description of example implementations refers to the accompanying drawings. The same reference numbers in different drawings may identify the same or similar elements.

To improve security in a computerized system, virtual identifiers may be used in place of permanent identifiers. For example, a VCN may be used in place of a PAN. Tokenizing the PAN into the VCN improves security because the VCN may be replaced, if compromised, more easily than the PAN. As a result, computer resources are conserved.

In order to provide a VCN to an authorized user, a primary user may send to the authorized user the VCN and any additional information, such as an expiry date or a card security code (also referred to as a “CSC,” a “card validation code,” a “CVC,” a “card verification value,” or a “CVV,” among other examples). Therefore, the authorized user may add the VCN to a mobile wallet application (or otherwise add the VCN to a mobile device), which is faster than the primary user providing a physical card to the authorized user.

In order to further improve security, the primary user may add restrictions to the VCN (e.g., a maximum amount, an expiry datetime, a category restriction, a location restriction, and/or a merchant restriction, among other examples). The mobile wallet application, though, is unaware of any restrictions. Therefore, the VCN may continue to appear in UIs generated by the mobile wallet application even after the VCN is expired. As a result, the mobile device of the authorized user wastes computing resources outputting an indication of the VCN, and an experience of the authorized user is degraded. In fact, because the VCN is displayed, the authorized user may engage in additional interactions (e.g., clicks, tips, scrolls, and/or voice commands) to use the mobile wallet application, which further wastes computing resources.

Some implementations described herein enable a mobile device to receive an indication of any expiry parameters associated with a virtual identifier (e.g., a VCN). Accordingly, the mobile device may automatically hide (or even remove) the virtual identifier from (one or more) UIs, output by the mobile device, in response to detecting expiry of the virtual identifier. As a result, the mobile device conserves computing resources as compared with continuing to output an indication of the virtual identifier after expiry. Additionally, in some implementations, the mobile device may indicate any expiry parameters to a user of the mobile device in order to improve the user’s experience with the virtual identifier.

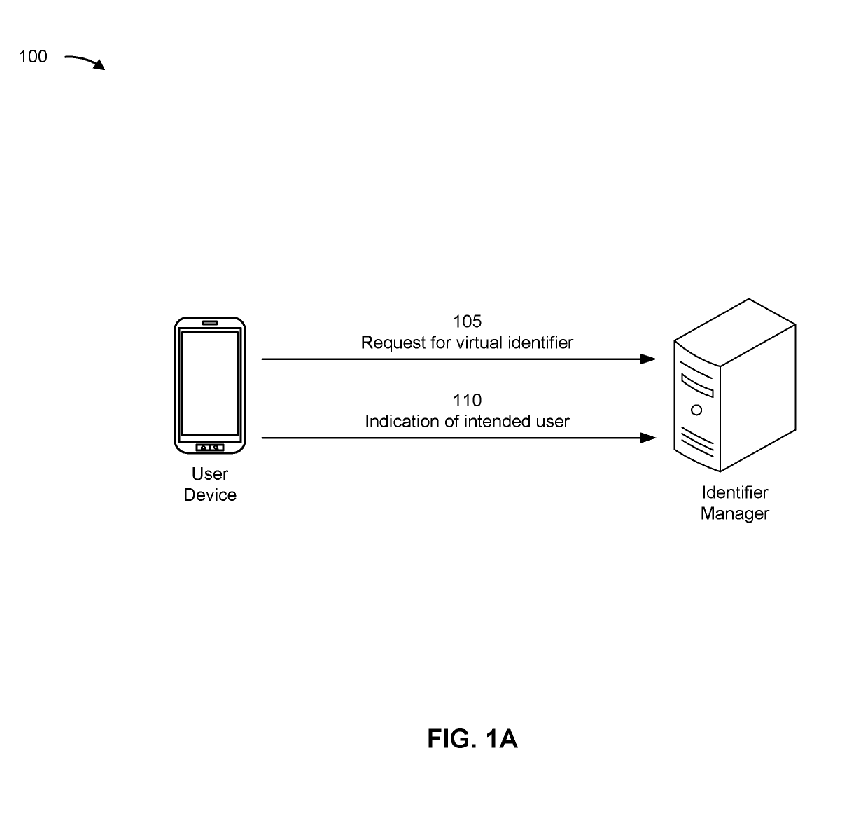

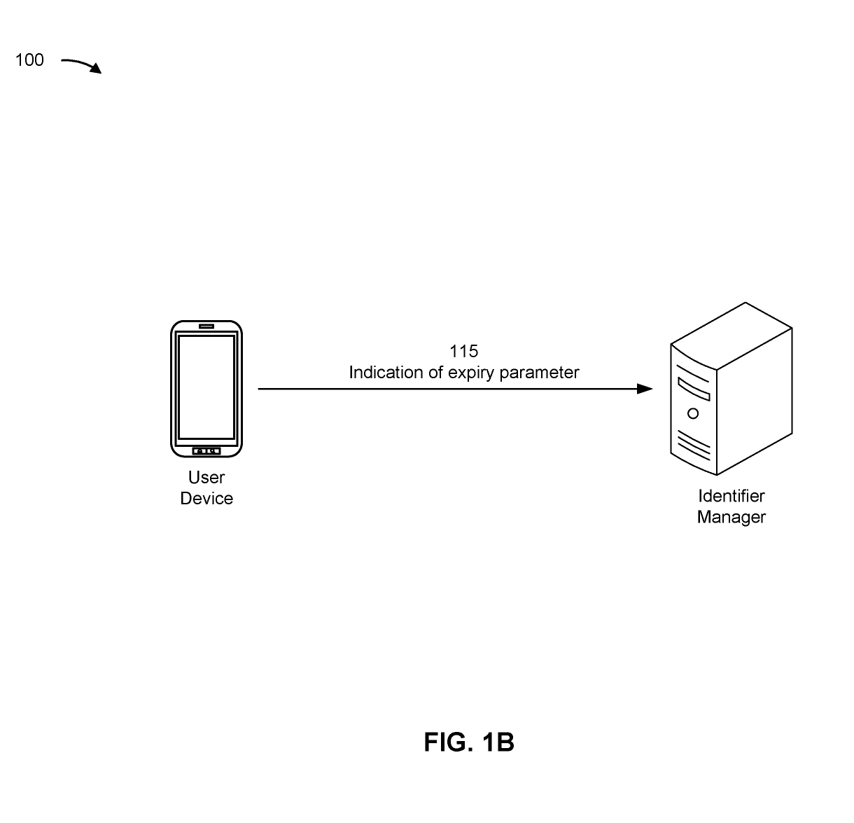

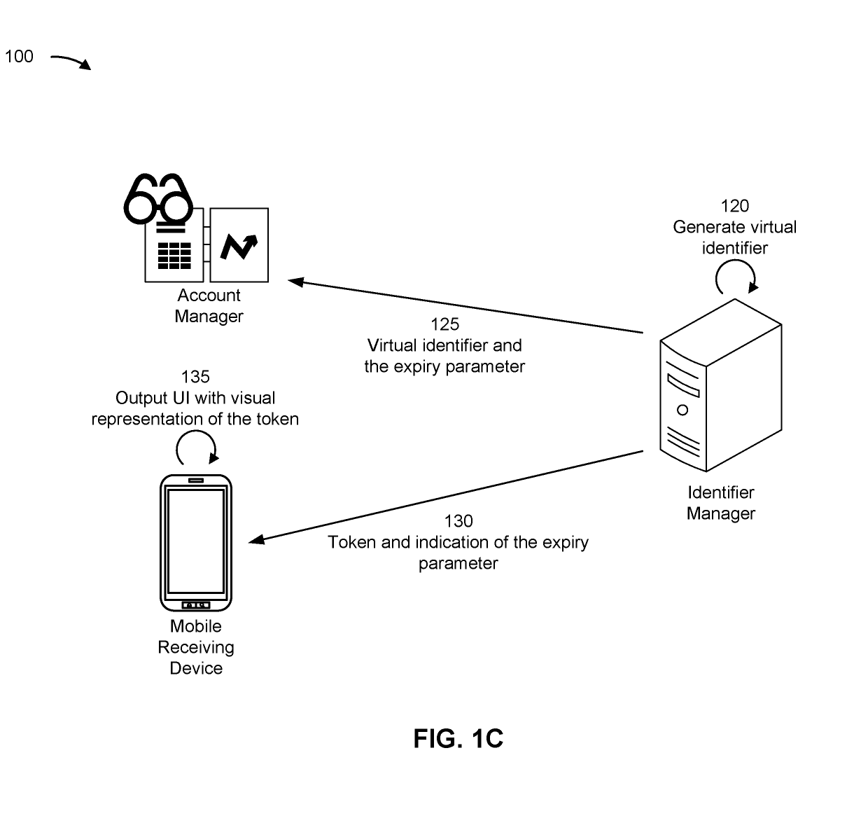

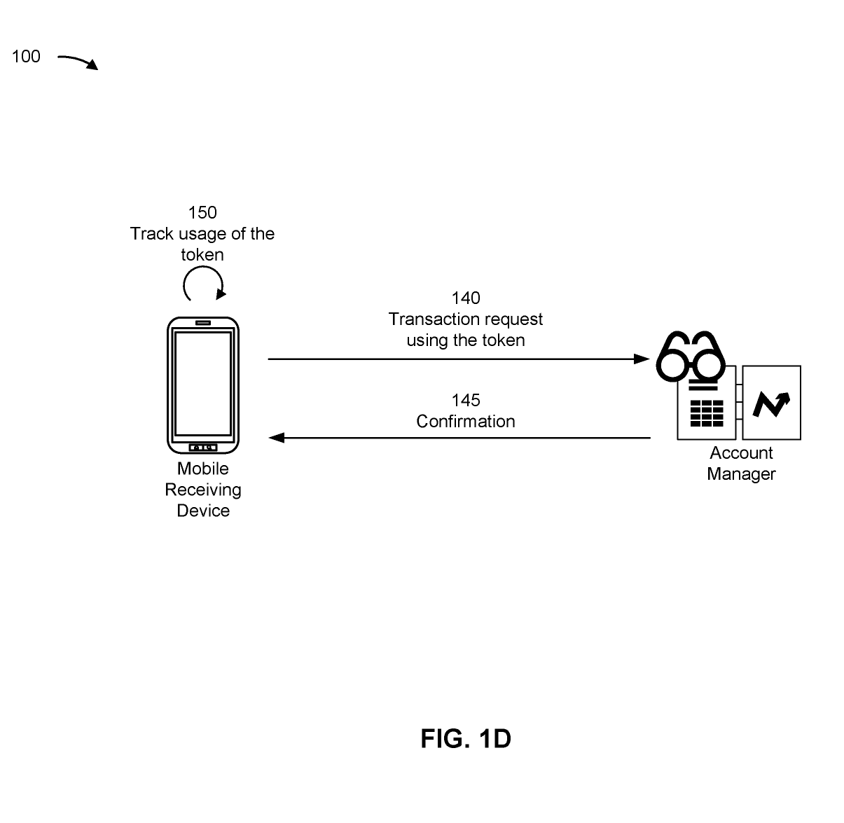

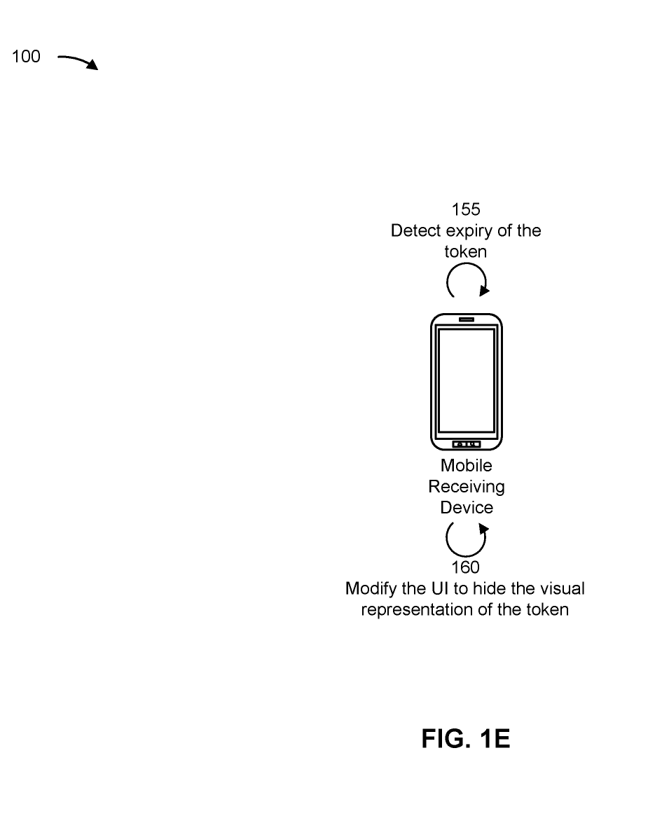

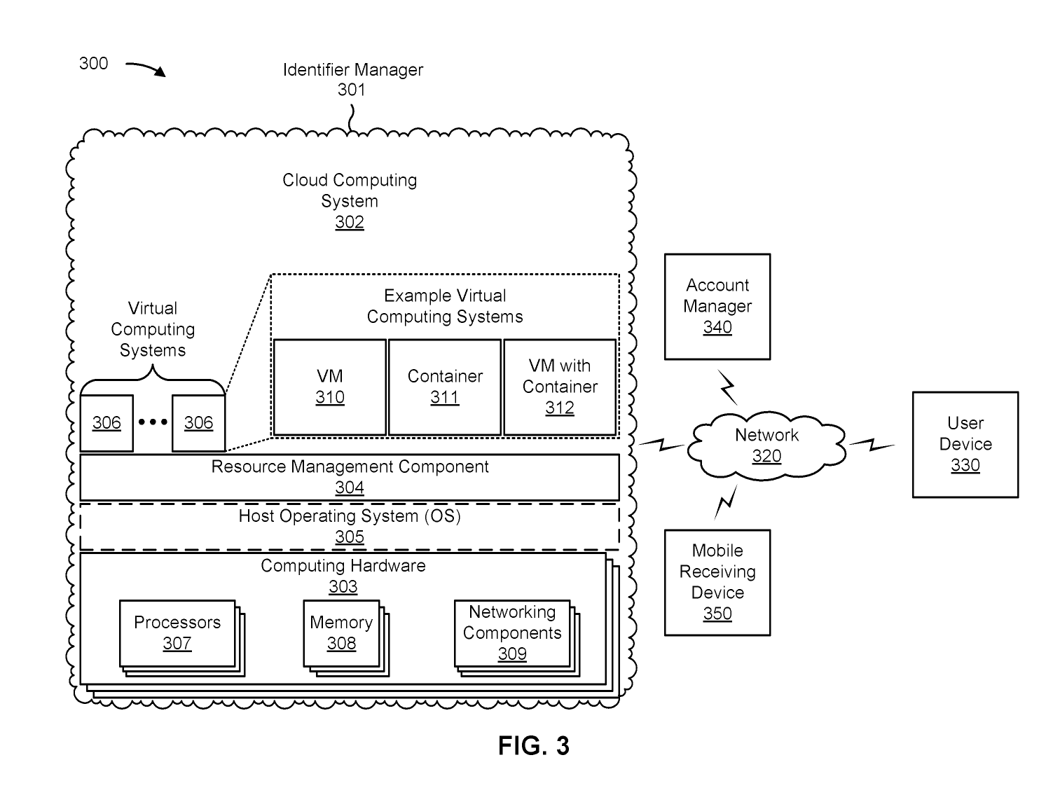

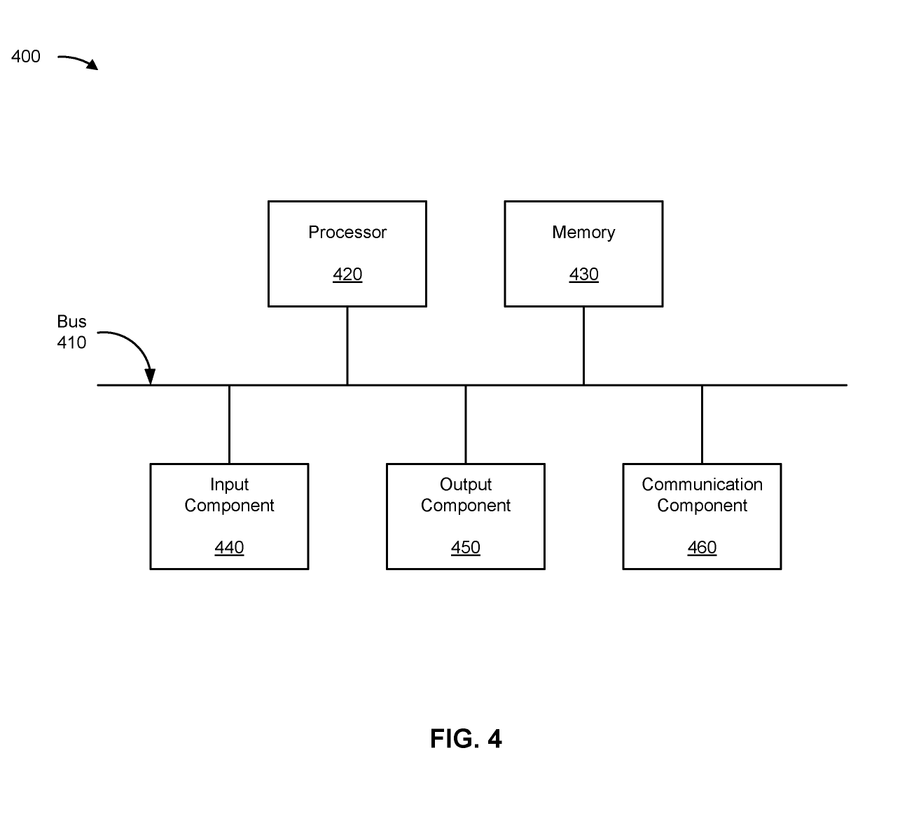

FIGS. 1A-1E are diagrams of an example 100 associated with providing virtual identifiers, with expiry parameters, to mobile devices. As shown in FIGS. 1A-1E, example 100 includes a user device, an identifier manager, an account manager, and a mobile receiving device. These devices are described in more detail in connection with FIGS. 3 and 4.

As shown in FIG. 1A and by reference number 105, the user device may transmit, and the identifier manager may receive, a request for a virtual identifier (to be associated with a permanent identifier). The request may include a hypertext transfer protocol (HTTP) request and/or an application programming interface (API) call. The request may include an indication of the permanent identifier.

In one example, a user of the user device may provide input (e.g., via an input component of the user device) by interacting with a UI, and the input may trigger the user device to transmit the request. In another example, the user of the user device may provide text-based input (e.g., using a shell or a command line, among other examples), and the input may trigger the user device to transmit the request. The input may indicate the permanent identifier.

In some implementations, the user device may transmit, and the identifier manager may receive, a set of credentials (e.g., associated with the permanent identifier). Accordingly, the identifier manager may verify the set of credentials before processing the request from the user device. In some implementations, the user device may include the set of credentials with the request. Alternatively, the user device may transmit the request, the identifier manager may prompt the user device for the set of credentials in response to the request, the user device may transmit the set of credentials in response to the prompt, and the identifier manager may process the request in response to verifying the set of credentials.

As shown by reference number 110, the user device may transmit, and the identifier manager may receive, an indication of an intended user (for the virtual identifier). The indication of the intended user may include an email address and/or a phone number, among other examples. The indication may be included in an HTTP message and/or as an argument to an API call.

In one example, the user of the user device may provide input (e.g., via an input component of the user device) by interacting with a UI, and the input may trigger the user device to transmit the indication of the intended user. In another example, the user of the user device may provide text-based input (e.g., using a shell or a command line, among other examples), and the input may trigger the user device to transmit the indication of the intended user. The input may indicate the intended user.

As shown in FIG. 1B and by reference number 115, the user device may transmit, and the identifier manager may receive, an indication of an expiry parameter (for the virtual identifier). The indication may be included in an HTTP message and/or as an argument to an API call. The expiry parameter may include an expiry datetime, an approved category, an approved merchant, an approved set of locations (or geographic zone or region), and/or a maximum amount, among other examples.

In one example, the user of the user device may provide input (e.g., via an input component of the user device) by interacting with a UI, and the input may trigger the user device to transmit the indication of the expiry parameter. In another example, the user of the user device may provide text-based input (e.g., using a shell or a command line, among other examples), and the input may trigger the user device to transmit the indication of the expiry parameter. The input may indicate the expiry parameter.

Although the example 100 is described using a sequence of messages between the user device and the identifier manager, other examples may include the user device transmitting, and the identifier manager receiving, a request for the virtual identifier that indicates the intended user (also referred to as the “target user”) for the virtual identifier, the permanent identifier to be associated with the virtual identifier, and the expiry parameter for the virtual identifier. For example, the user device may cache (or otherwise store) the permanent identifier, the indication of the intended user, and the indication of the expiry parameter for transmitting to the identifier manager in a single request (or other message).

As shown in FIG. 1C and by reference number 120, the identifier manager may generate the virtual identifier. The identifier manager may generate the virtual identifier in response to the request from the user device (e.g., as described above). In some implementations, the identifier manager may generate (or obtain) the virtual identifier by applying an algorithmic formula to the permanent identifier. Additionally, or alternatively, the identifier manager may generate the virtual identifier by generating numbers (e.g., one or more numbers) pseudorandomly and combining the generated numbers with fixed numbers (e.g., one or more fixed numbers) to form the virtual identifier. For example, the fixed numbers may include an indicator that the virtual identifier is virtual (and not permanent) and/or an indication of a card network associated with the virtual identifier, among other examples.

As shown by reference number 125, the identifier manager may transmit, and the account manager may receive, the virtual identifier for association with the permanent identifier. Therefore, the account manager may authorize future requests associated with the virtual identifier (e.g., by detokenizing the virtual identifier to the permanent identifier).

As further shown by reference number 125, the identifier manager may transmit, and the account manager may receive, an indication of the expiry parameter for association with the virtual identifier. Therefore, the account manager may authorize future requests, associated with the virtual identifier, only if the virtual identifier is unexpired (e.g., as determined using the expiry parameter).

Although the example 100 depicts the identifier manager as separate from the account manager, other examples may include the account manager as at least partially integrated (e.g., virtually, logically, and/or physically) with the identifier manager. Therefore, operations described herein as performed by the account manager may be performed by the identifier manager.

As shown by reference number 130, the identifier manager may transmit, and the mobile receiving device may receive (e.g., using an application executed by the mobile receiving device), a token encoding the virtual identifier. The application executed by the mobile receiving device may include a digital wallet that (securely) stores the token for use in future requests (e.g., for transactions or other events). The identifier manager may transmit, and the mobile receiving device may receive, the token in response to the request from the user device.

In some implementations, the identifier manager may transmit, and the mobile receiving device may receive (e.g., using the application executed by the mobile receiving device), an encrypted token encoding the virtual identifier. The encrypted token may authorize the application executed by the mobile receiving device to use the virtual identifier (e.g., in future requests for transactions or other events).

In some implementations, the identifier manager may determine the mobile receiving device based on the intended user. For example, the identifier manager may map the indication of the intended user (e.g., included in the request from, or otherwise transmitted by, the user device) to an identifier of the mobile receiving device. The identifier manager may map a name of the user and/or a username of the user to an Internet protocol (IP) address associated with the mobile receiving device and/or a medium access control (MAC) address associated with the mobile receiving device. Therefore, the identifier manager may transmit the token to the mobile receiving device based on the identifier of the mobile receiving device. Alternatively, the identifier manager may transmit the token to the mobile receiving device based on the indication of the intended user. For example, the identifier manager may directly use an email address associated with the intended user to transmit an email message with the token or may directly use a phone number associated with the intended user to transmit a text message with the token.

In some implementations, the identifier manager may verify the user of the mobile receiving device. For example, the identifier manager may verify the user using a set of credentials (e.g., received from the mobile receiving device). The set of credentials may include a certificate and/or a signature generated by the application executed by the mobile receiving device. Therefore, the identifier manager may transmit, and the mobile receiving device may receive, the token in response to (the identifier manager verifying) the set of credentials.

Rather than verifying the user directly, the identifier manager may use an authentication service to verify the user. The authentication service may provide an Open Authorization (OAuth) service (e.g., for the identifier manager, the user device, and/or the mobile receiving device). For example, the mobile receiving device may transmit, and the authentication service may receive, a set of credentials (e.g., a username and password, a passkey, a certificate, a signature, a private key, and/or biometric information, among other examples). Accordingly, the authentication service may verify the set of credentials and generate a data structure (e.g., a certificate and/or a signature) that verifies the set of credentials (and thus verifies the user and/or the application executed by the mobile receiving device). The authentication service may transmit, and the identifier manager may receive, the data structure such that the authentication service may verify the user using the data structure.

As further shown by reference number 130, the identifier manager may transmit, and the mobile receiving device may receive (e.g., using the application executed by the mobile receiving device), an indication of the expiry parameter (to associate with the token). In some implementations, the (encrypted) token may have an integrated expiry datetime associated with verification of the set of credentials from the mobile receiving device, and so the identifier manager may indicate the expiry parameter for the virtual identifier that is separate from expiry of the (encrypted) token. For example, the identifier manager may transmit, and the mobile receiving device may receive (e.g., using the application executed by the mobile receiving device), a message including both the token and the indication of the expiry parameter. The message may be encrypted (e.g., in addition to encryption of the token).

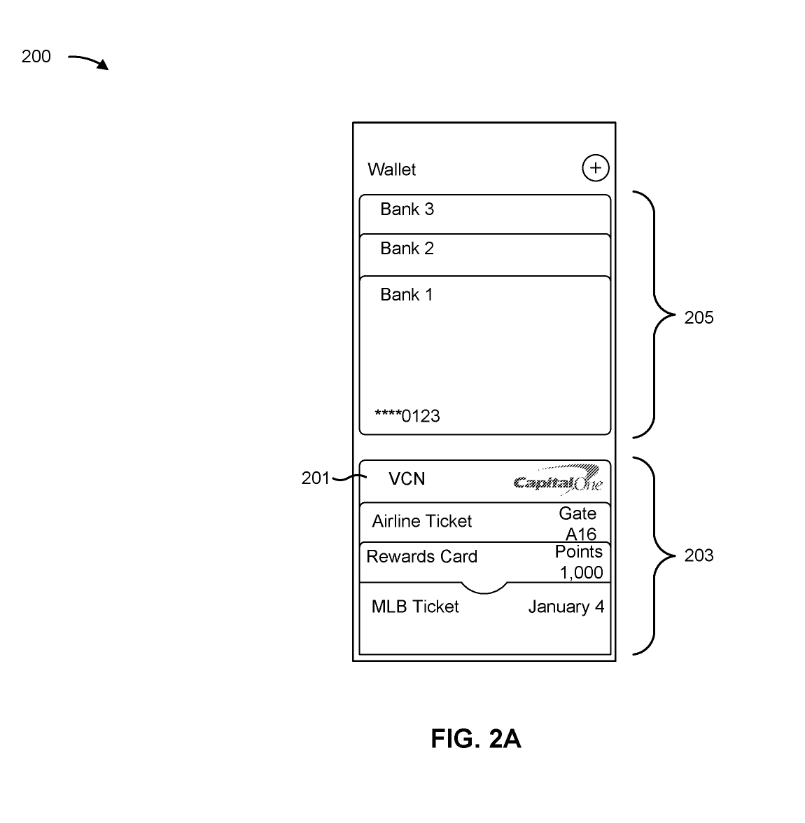

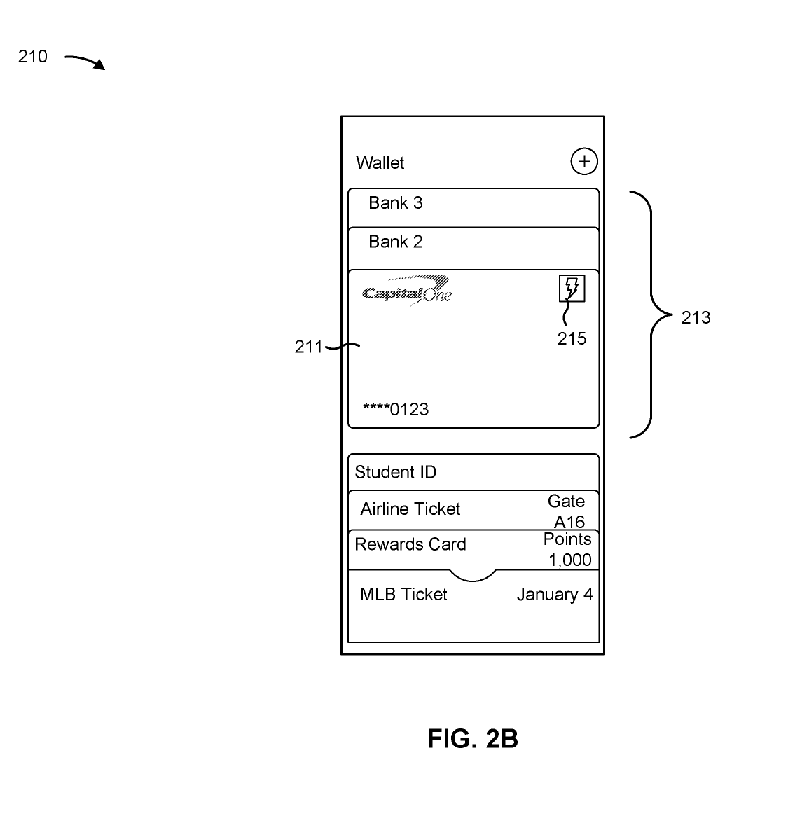

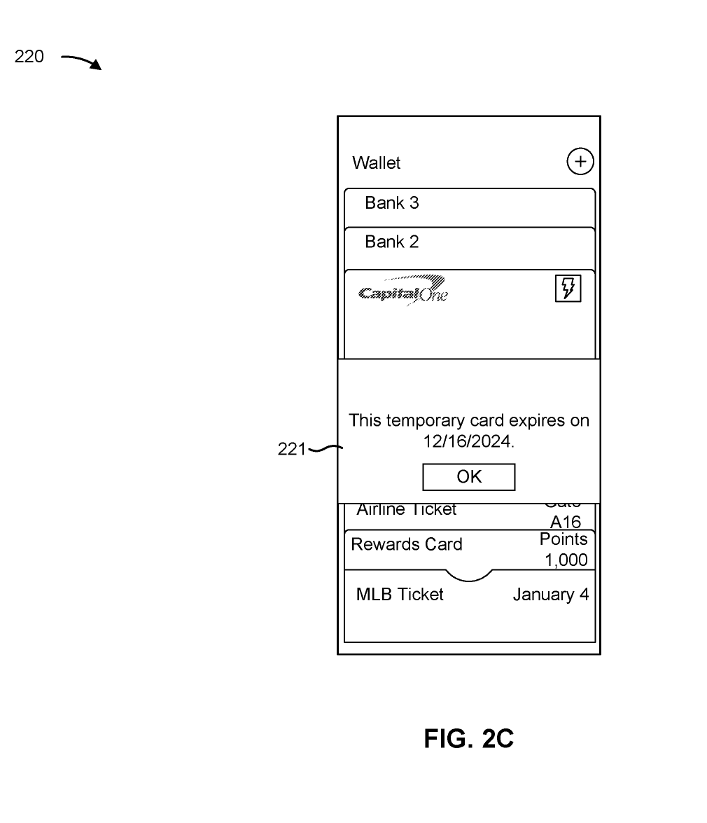

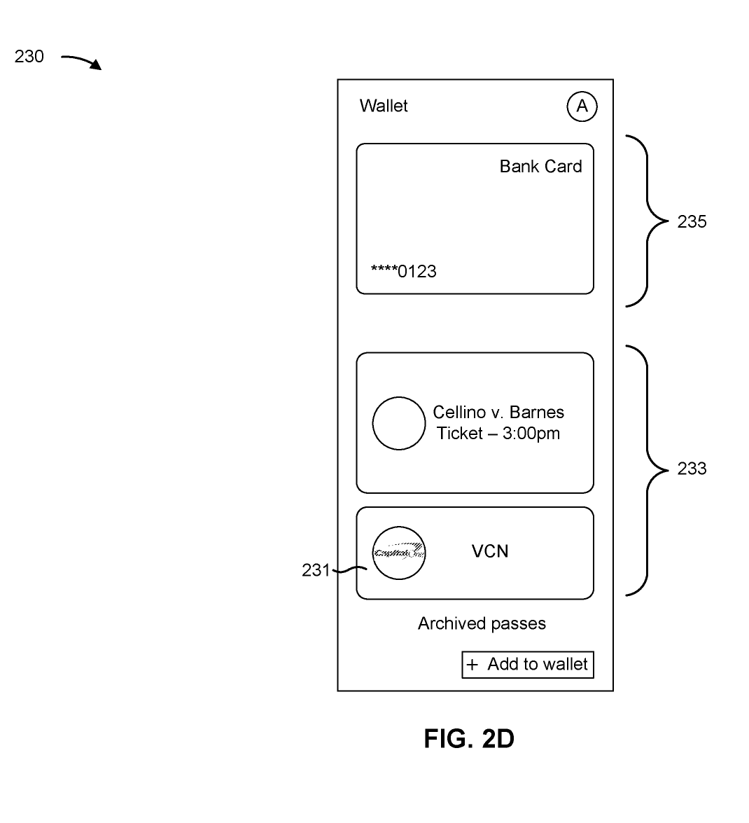

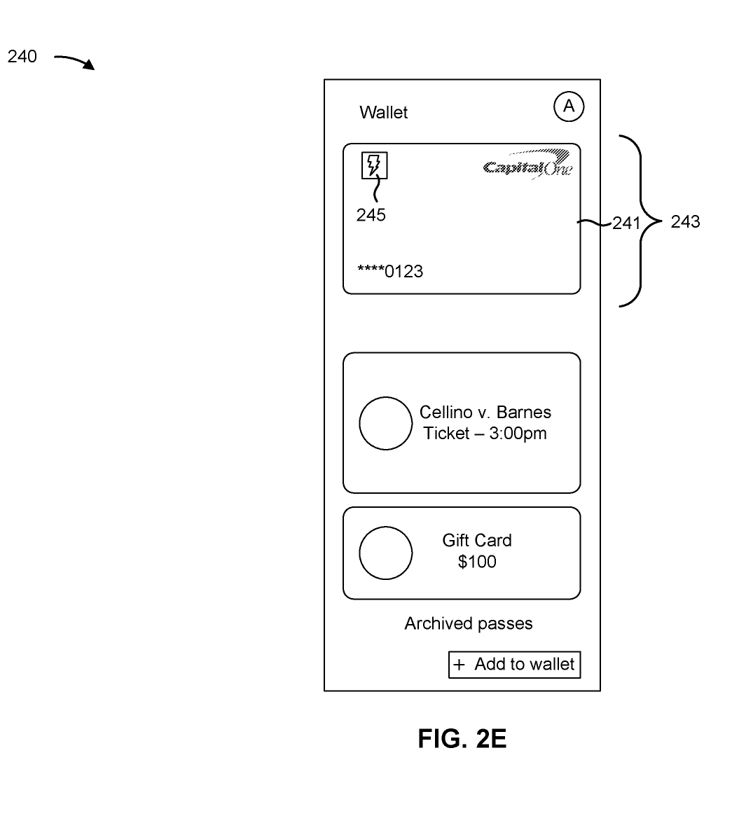

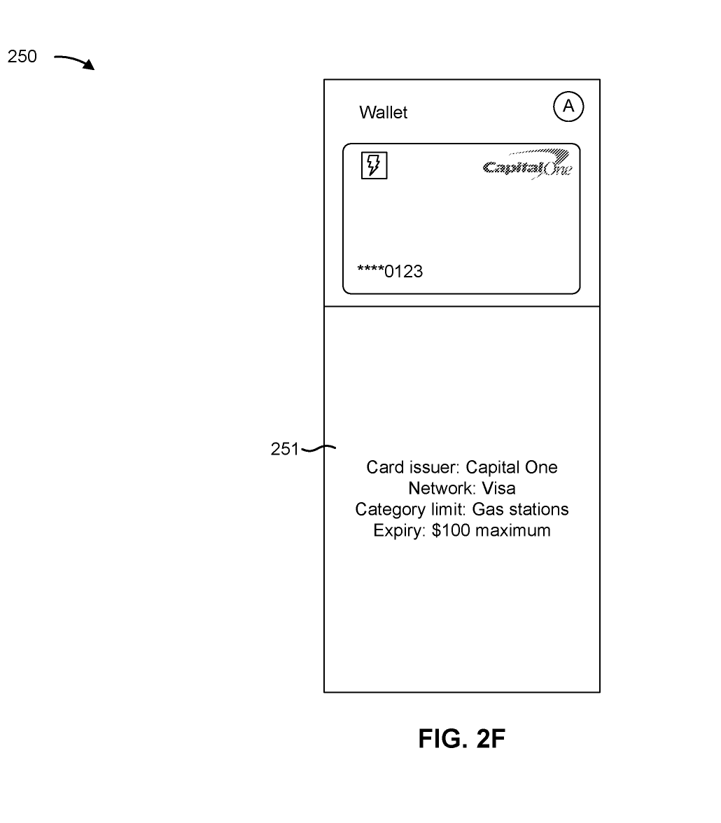

As shown by reference number 135, the mobile receiving device may output a UI including a graphical representation of the token. The graphical representation of the token may be distinguished from an additional graphical representation (e.g., at least one additional graphical representation) of a non-virtual identifier (e.g., at least one non-virtual identifier). For example, as described in connection with FIGS. 2A and 2D, the graphical representation may be distinguished by being grouped in a first area of the UI that is separate from a second area of the UI that includes the additional graphical representation. Additionally, or alternatively, as described in connection with FIGS. 2B and 2E, the graphical representation may be distinguished by including a visual indicator that is omitted from the additional graphical representation.

Even though (the application executed by the) the mobile receiving device is using the virtual identifier, (the application executed by the) the mobile receiving device may output a portion of the permanent identifier in order to improve a user’s experience. For example, the identifier manager may transmit, and the mobile receiving device may receive (e.g., using the application executed by the mobile receiving device), a portion of the permanent identifier. The portion of the permanent identifier may include, among other examples, a final four digits of the permanent identifier. Accordingly, (the application executed by the) the mobile receiving device may output the portion of the permanent identifier to the user (e.g., using an output component of the mobile receiving device).

In some implementations, the mobile receiving device may receive an indication of an interaction with the graphical representation of the token. For example, the user of the mobile receiving device may click, tap, and/or use a voice command (e.g., via an input component of the mobile receiving device) to interact with the graphical representation. Accordingly, the mobile receiving device may receive the indication of the interaction via the input component. The mobile receiving device may update the UI in response to the indication of the interaction. For example, the mobile receiving device may update the UI to indicate the expiry parameter.

In some implementations, the mobile receiving device may update the UI by generating a pop-up window, overlaid on the UI, indicating the expiry parameter, as described in connection with FIG. 2C. Alternatively, the mobile receiving device may update the UI by generating a new screen with information about the token that indicates the expiry parameter, as described in connection with FIG. 2F.

As shown in FIG. 1D, the mobile receiving device may use the token (e.g., to perform a transaction or another type of event). For example, the mobile receiving device may transmit, and the account manager may receive, a transaction request using the token, as shown by reference number 140. The transaction request may include the token and/or a signature generated using the token. The mobile receiving device may transmit the transaction request directly or via one or more intermediary devices (e.g., a website server, a payment processor, an automated clearing house (ACH) device, an interchange device, and/or a device controlled by a financial institution, among other examples). The account manager may detokenize the virtual identifier (e.g., indicated in the transaction request via the token) into the permanent identifier and determine to approve the transaction request. Accordingly, as shown by reference number 145, the account manager may transmit, and the mobile receiving device may receive, a confirmation (that the transaction request was approved and processed). As shown by reference number 150, (the application executed by) the mobile receiving device may track usage of the token. For example, (the application executed by) the mobile receiving device may track transactions (e.g., one or more transactions) performed using the token (e.g., including the approved transaction request).

As shown in FIG. 1E and by reference number 155, the mobile receiving device may detect expiry of the token. For example, the mobile receiving device may determine, based on the expiry parameter, that the token has expired. In one example, the mobile receiving device may determine that a datetime, indicated by the expiry parameter, has passed. In another example, the mobile receiving device may determine that the transactions satisfy a transaction threshold indicated by the expiry parameter. In another example, the mobile receiving device may detemrine that a total amount of the transactions satisfy a spend threshold indicated by the expiry parameter.

As shown by reference number 160, the mobile receiving device may modify the UI to hide the graphical representation of the token. The mobile receiving device may modify the UI in response to determining that the token has expired. In one example, the mobile receiving device may remove the graphical representation from the UI altogether. In another example, the mobile receiving device may move the graphical representation of the token to a hidden section of the UI (accessible via an interaction with the UI), as described in connection with FIGS. 2D and 2E.

By using techniques as described in connection with FIGS. 1A-1E, the mobile receiving device may automatically hide (or even remove) the graphical representation of the token in response to detecting expiry of the token. As a result, the mobile device conserves computing resources as compared with continuing to output the graphical representation even after the token expires.

As indicated above, FIGS. 1A-1E are provided as an example. Other examples may differ from what is described with regard to FIGS. 1A-1E.

FIGS. 2A, 2B, 2C, 2D, 2E and 2F, are diagrams of example UIs 200, 210, 220, 230, 240, and 250, respectively, associated with indicating a virtual identifier. The example UIs 200, 210, 220, 230, 240, and 250 may be output by (an output component of) a mobile receiving device based on instructions received from an identifier manager. These devices are described in more detail in connection with FIGS. 3 and 4.

As shown in FIG. 2A, the example UI 200 may include a graphical representation 201 of a token encoding a virtual identifier. For example, the graphical representation 201 in FIG. 2A includes a “VCN” indication and a logo. Other examples may additionally, or alternatively, include, in the graphical representation 201, a portion of the virtual identifier and/or a portion of a permanent identifier associated with the virtual identifier, among other examples. In FIG. 2A, the graphical representation 201 is distinguished from graphical representations of non-virtual identifiers by being grouped in a first area 203 of the UI. The first area 203 is separate from a second area 205 of the UI that includes the graphical representations of the non-virtual identifiers. In FIG. 2A, the first area 203 is separate from the second area 205 because there are pixels between the areas 203 and 205 (e.g., causing a visual gap). Other examples may use a line or another type of shape to distinguish the first area 203 from the second area 205. In FIG. 2A, the first area 203 may also be associated with temporary items (e.g., event tickets and/or travel tickets, among other examples) and/or reward memberships.

As shown in FIG. 2B, the example UI 210 may include a graphical representation 211 of a token encoding a virtual identifier. For example, the graphical representation 211 in FIG. 2B includes a logo and a portion of a permanent identifier associated with the virtual identifier. Other examples may additionally, or alternatively, include, in the graphical representation 211, a “VCN” indication and/or a portion of the virtual identifier, among other examples. In FIG. 2B, the graphical representation 201 is included in a same area 213 as graphical representations of non-virtual identifiers. Accordingly, the graphical representation 211 may be distinguished, from the graphical representations of the non-virtual identifiers, by including a visual indicator 215 (that is omitted from the graphical representations of the non-virtual identifiers). In FIG. 2B, the visual indicator 215 is a lightning bolt, but other visual indicators may be used.

Example UIs 200 and 210 may be combined. In a combinatory example, a graphical representation of a virtual identifier may be included in a separate area from an area with graphical representations of non-virtual identifiers and may also include a visual indicator that is omitted from the graphical representations of the non-virtual identifiers.

As shown in FIG. 2C, the example UI 220 may be a modified version of the example UI 210 in response to interaction with the graphical representation 211. In FIG. 2C, the example UI 220 includes a pop-up window 221, overlaid on the UI, indicating an expiry parameter associated with the virtual identifier. Although the expiry parameter is an expiry date in FIG. 2C, other examples may include a maximum amount, among other examples.

As shown in FIG. 2D, the example UI 230 may include a graphical representation 231 of a token encoding a virtual identifier. For example, the graphical representation 231 in FIG. 2D includes a “VCN” indication and a logo. Other examples may additionally, or alternatively, include, in the graphical representation 231, a portion of the virtual identifier and/or a portion of a permanent identifier associated with the virtual identifier, among other examples. In FIG. 2D, the graphical representation 231 is distinguished from graphical representations of non-virtual identifiers by being grouped in a first area 233 of the UI. The first area 233 is separate from a second area 235 of the UI that includes the graphical representations of the non-virtual identifiers. In FIG. 2D, the first area 233 is separate from the second area 235 because there are pixels between the areas 233 and 235 (e.g., causing a visual gap). Other examples may use a line or another type of shape to distinguish the first area 233 from the second area 235. In FIG. 2D, the first area 233 may also be associated with temporary items (e.g., event tickets and/or travel tickets, among other examples) and/or reward memberships.

As shown in FIG. 2E, the example UI 240 may include a graphical representation 241 of a token encoding a virtual identifier. For example, the graphical representation 241 in FIG. 2E includes a logo and a portion of a permanent identifier associated with the virtual identifier. Other examples may additionally, or alternatively, include, in the graphical representation 241, a “VCN” indication and/or a portion of the virtual identifier, among other examples. In FIG. 2E, the graphical representation 241 is included in a same area 243 as graphical representations of non-virtual identifiers. Accordingly, the graphical representation 241 may be distinguished, from the graphical representations of the non-virtual identifiers, by including a visual indicator 245 (that is omitted from the graphical representations of the non-virtual identifiers). In FIG. 2E, the visual indicator 245 is a lightning bolt, but other visual indicators may be used.

Example UIs 230 and 240 may be combined. In a combinatory example, a graphical representation of a virtual identifier may be included in a separate area from an area with graphical representations of non-virtual identifiers and may also include a visual indicator that is omitted from the graphical representations of the non-virtual identifiers.

As shown in FIG. 2F, the example UI 250 may be a modified version of the example UI 240 in response to interaction with the graphical representation 241. In FIG. 2F, the example UI 250 includes a new screen 251 with information about the token that indicates the expiry parameter. In FIG. 2F, the new screen 251 indicates an issuer, a network, a category restriction, and the expiry parameter associated with the token, but other examples may include less information or more information. Although the expiry parameter is an expiry date in FIG. 2F, other examples may include a maximum amount, among other examples.

As indicated above, FIGS. 2A-2F are provided as examples. Other examples may differ from what is described with regard to FIGS. 2A-2F.

FIG. 3 is a diagram of an example environment 300 in which systems and/or methods described herein may be implemented. As shown in FIG. 3, environment 300 may include an identifier manager 301, which may include one or more elements of and/or may execute within a cloud computing system 302. The cloud computing system 302 may include one or more elements 303-312, as described in more detail below. As further shown in FIG. 3, environment 300 may include a network 320, a user device 330, an account manager 340, and/or a mobile receiving device 350. Devices and/or elements of environment 300 may interconnect via wired connections and/or wireless connections.

The cloud computing system 302 may include computing hardware 303, a resource management component 304, a host operating system (OS) 305, and/or one or more virtual computing systems 306. The cloud computing system 302 may execute on, for example, an Amazon Web Services platform, a Microsoft Azure platform, or a Snowflake platform. The resource management component 304 may perform virtualization (e.g., abstraction) of computing hardware 303 to create the one or more virtual computing systems 306. Using virtualization, the resource management component 304 enables a single computing device (e.g., a computer or a server) to operate like multiple computing devices, such as by creating multiple isolated virtual computing systems 306 from computing hardware 303 of the single computing device. In this way, computing hardware 303 can operate more efficiently, with lower power consumption, higher reliability, higher availability, higher utilization, greater flexibility, and lower cost than using separate computing devices.

The computing hardware 303 may include hardware and corresponding resources from one or more computing devices. For example, computing hardware 303 may include hardware from a single computing device (e.g., a single server) or from multiple computing devices (e.g., multiple servers), such as multiple computing devices in one or more data centers. As shown, computing hardware 303 may include one or more processors 307, one or more memories 308, and/or one or more networking components 309. Examples of a processor, a memory, and a networking component (e.g., a communication component) are described elsewhere herein.

The resource management component 304 may include a virtualization application (e.g., executing on hardware, such as computing hardware 303) capable of virtualizing computing hardware 303 to start, stop, and/or manage one or more virtual computing systems 306. For example, the resource management component 304 may include a hypervisor (e.g., a bare-metal or Type 1 hypervisor, a hosted or Type 2 hypervisor, or another type of hypervisor) or a virtual machine monitor, such as when the virtual computing systems 306 are virtual machines 310. Additionally, or alternatively, the resource management component 304 may include a container manager, such as when the virtual computing systems 306 are containers 311. In some implementations, the resource management component 304 executes within and/or in coordination with a host operating system 305.

A virtual computing system 306 may include a virtual environment that enables cloud-based execution of operations and/or processes described herein using computing hardware 303. As shown, a virtual computing system 306 may include a virtual machine 310, a container 311, or a hybrid environment 312 that includes a virtual machine and a container, among other examples. A virtual computing system 306 may execute one or more applications using a file system that includes binary files, software libraries, and/or other resources required to execute applications on a guest operating system (e.g., within the virtual computing system 306) or the host operating system 305.

Although the identifier manager 301 may include one or more elements 303-312 of the cloud computing system 302, may execute within the cloud computing system 302, and/or may be hosted within the cloud computing system 302, in some implementations, the identifier manager 301 may not be cloud-based (e.g., may be implemented outside of a cloud computing system) or may be partially cloud-based. For example, the identifier manager 301 may include one or more devices that are not part of the cloud computing system 302, such as device 400 of FIG. 4, which may include a standalone server or another type of computing device. The identifier manager 301 may perform one or more operations and/or processes described in more detail elsewhere herein.

The network 320 may include one or more wired and/or wireless networks. For example, the network 320 may include a cellular network, a public land mobile network (PLMN), a local area network (LAN), a wide area network (WAN), a private network, the Internet, and/or a combination of these or other types of networks. The network 320 enables communication among the devices of the environment 300.

The user device 330 may include one or more devices capable of receiving, generating, storing, processing, and/or providing information associated with virtual identifiers, as described elsewhere herein. The user device 330 may include a communication device and/or a computing device. For example, the user device 330 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device. The user device 330 may communicate with one or more other devices of environment 300, as described elsewhere herein.

The account manager 340 may include one or more devices capable of processing, authorizing, and/or facilitating an event (e.g., a transaction). For example, the account manager 340 may include one or more servers and/or computing hardware (e.g., in a cloud computing environment or separate from a cloud computing environment) configured to receive and/or store information associated with processing an electronic event. The account manager 340 may process an event, such as to approve (e.g., permit, authorize, or the like) or decline (e.g., reject, deny, or the like) the event and/or to complete the event if the event is approved. The account manager 340 may be associated with a financial institution (e.g., a bank, a lender, a credit card company, or a credit union). For example, the account manager 340 may be associated with an issuing bank and/or an acquiring bank (or merchant bank). The account manager 340 may communicate with one or more other devices of environment 300, as described elsewhere herein.

The mobile receiving device 350 may include one or more devices capable of receiving, generating, storing, processing, and/or providing information associated with virtual identifiers, as described elsewhere herein. The mobile receiving device 350 may include a communication device and/or a computing device. For example, the mobile receiving device 350 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device. The mobile receiving device 350 may execute a digital wallet application or another similar type of application, as described herein. The mobile receiving device 350 may communicate with one or more other devices of environment 300, as described elsewhere herein.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of the environment 300 may perform one or more functions described as being performed by another set of devices of the environment 300.

FIG. 4 is a diagram of example components of a device 400 associated with providing virtual identifiers, with expiry parameters, to mobile devices. The device 400 may correspond to a user device 330, an account manager 340, and/or a mobile receiving device 350. In some implementations, a user device 330, an account manager 340, and/or a mobile receiving device 350 may include one or more devices 400 and/or one or more components of the device 400. As shown in FIG. 4, the device 400 may include a bus 410, a processor 420, a memory 430, an input component 440, an output component 450, and/or a communication component 460.

The bus 410 may include one or more components that enable wired and/or wireless communication among the components of the device 400. The bus 410 may couple together two or more components of FIG. 4, such as via operative coupling, communicative coupling, electronic coupling, and/or electric coupling. For example, the bus 410 may include an electrical connection (e.g., a wire, a trace, and/or a lead) and/or a wireless bus. The processor 420 may include a central processing unit, a graphics processing unit, a microprocessor, a controller, a microcontroller, a digital signal processor, a field-programmable gate array, an application-specific integrated circuit, and/or another type of processing component. The processor 420 may be implemented in hardware, firmware, or a combination of hardware and software. In some implementations, the processor 420 may include one or more processors capable of being programmed to perform one or more operations or processes described elsewhere herein.

The memory 430 may include volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 may store information, one or more instructions, and/or software (e.g., one or more software applications) related to the operation of the device 400. In some implementations, the memory 430 may include one or more memories that are coupled (e.g., communicatively coupled) to one or more processors (e.g., processor 420), such as via the bus 410. Communicative coupling between a processor 420 and a memory 430 may enable the processor 420 to read and/or process information stored in the memory 430 and/or to store information in the memory 430.

The input component 440 may enable the device 400 to receive input, such as user input and/or sensed input. For example, the input component 440 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 450 may enable the device 400 to provide output, such as via a display, a speaker, and/or a light-emitting diode. The communication component 460 may enable the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

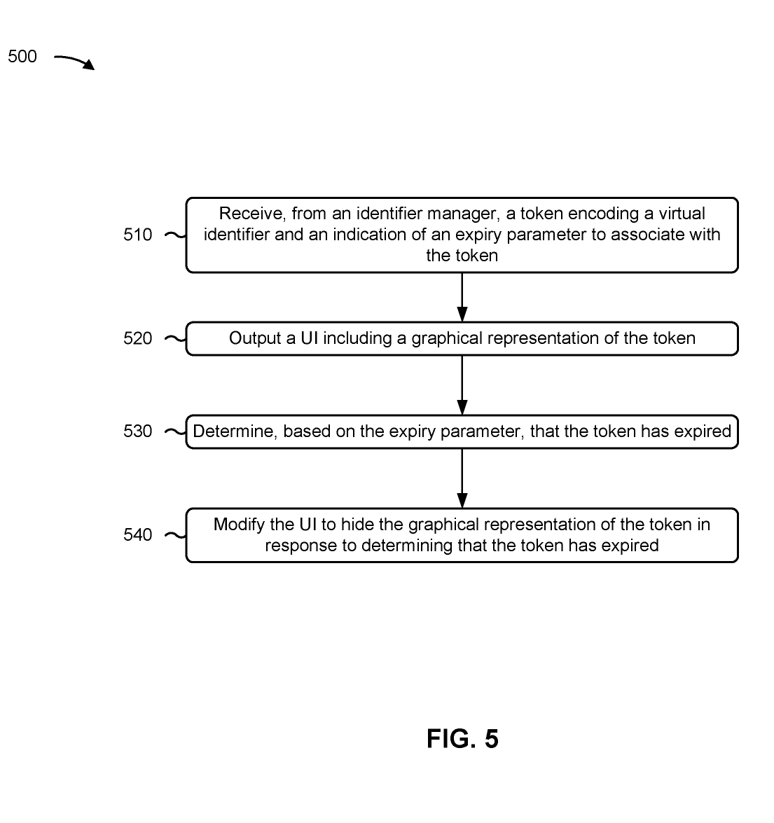

FIG. 5 is a flowchart of an example process 500 associated with receiving virtual identifiers with expiry parameters. In some implementations, one or more process blocks of FIG. 5 may be performed by a mobile receiving device 350. In some implementations, one or more process blocks of FIG. 5 may be performed by another device or a group of devices separate from or including the mobile receiving device 350, such as an identifier manager 301, a user device 330, and/or an account manager 340. Additionally, or alternatively, one or more process blocks of FIG. 5 may be performed by one or more components of the device 400, such as processor 420, memory 430, input component 440, output component 450, and/or communication component 460.

As shown in FIG. 5, process 500 may include receiving, from an identifier manager, a token encoding a virtual identifier and an indication of an expiry parameter to associate with the token (block 510). For example, the mobile receiving device 350 (e.g., using processor 420, memory 430, and/or communication component 460) may receive, from an identifier manager, a token encoding a virtual identifier and an indication of an expiry parameter to associate with the token, as described above in connection with reference number 130 of FIG. 1C. As an example, the mobile receiving device 350 may receive the token and the indication using an application executed by the mobile receiving device 350. The application may include a digital wallet that (securely) stores the token for use in future requests (e.g., for transactions or other events). The mobile receiving device 350 may authenticate itself to the identifier manager in order to receive the token and the indication.

As further shown in FIG. 5, process 500 may include outputting a UI including a graphical representation of the token (block 520). For example, the mobile receiving device 350 (e.g., using processor 420, memory 430, and/or output component 450) may output a UI including a graphical representation of the token, as described above in connection with reference number 135 of FIG. 1C. As an example, as described in connection with FIGS. 2A and 2D, the graphical representation may be distinguished from at least one additional graphical representation of at least one non-virtual identifier by being grouped in a first area of the UI that is separate from a second area of the UI that includes the at least one additional graphical representation. Additionally, or alternatively, as described in connection with FIGS. 2B and 2E, the graphical representation may be distinguished from at least one additional graphical representation of at least one non-virtual identifier by including a visual indicator that is omitted from the at least one additional graphical representation.

As further shown in FIG. 5, process 500 may include determining, based on the expiry parameter, that the token has expired (block 530). For example, the mobile receiving device 350 (e.g., using processor 420 and/or memory 430) may determine, based on the expiry parameter, that the token has expired, as described above in connection with reference number 155 of FIG. 1E. As an example, the mobile receiving device 350 may determine that a datetime, indicated by the expiry parameter, has passed. In another example, the mobile receiving device 350 may determine that one or more transactions, performed using the token, satisfy a transaction threshold indicated by the expiry parameter. In another example, the mobile receiving device 350 may detemrine that a total amount of transactions, performed using the token, satisfy a spend threshold indicated by the expiry parameter.

As further shown in FIG. 5, process 500 may include modifying the UI to hide the graphical representation of the token in response to determining that the token has expired (block 540). For example, the mobile receiving device 350 (e.g., using processor 420, memory 430, and/or output component 450) may modify the UI to hide the graphical representation of the token in response to determining that the token has expired, as described above in connection with reference number 160 of FIG. 1E. As an example, the mobile receiving device 350 may remove the graphical representation from the UI altogether. In another example, the mobile receiving device 350 may move the graphical representation of the token to a hidden section of the UI (accessible via an interaction with the UI), as described in connection with FIGS. 2D and 2E.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel. The process 500 is an example of one process that may be performed by one or more devices described herein. These one or more devices may perform one or more other processes based on operations described herein, such as the operations described in connection with FIGS. 1A-1E and/or FIGS. 2A-2F. Moreover, while the process 500 has been described in relation to the devices and components of the preceding figures, the process 500 can be performed using alternative, additional, or fewer devices and/or components. Thus, the process 500 is not limited to being performed with the example devices, components, hardware, and software explicitly enumerated in the preceding figures.

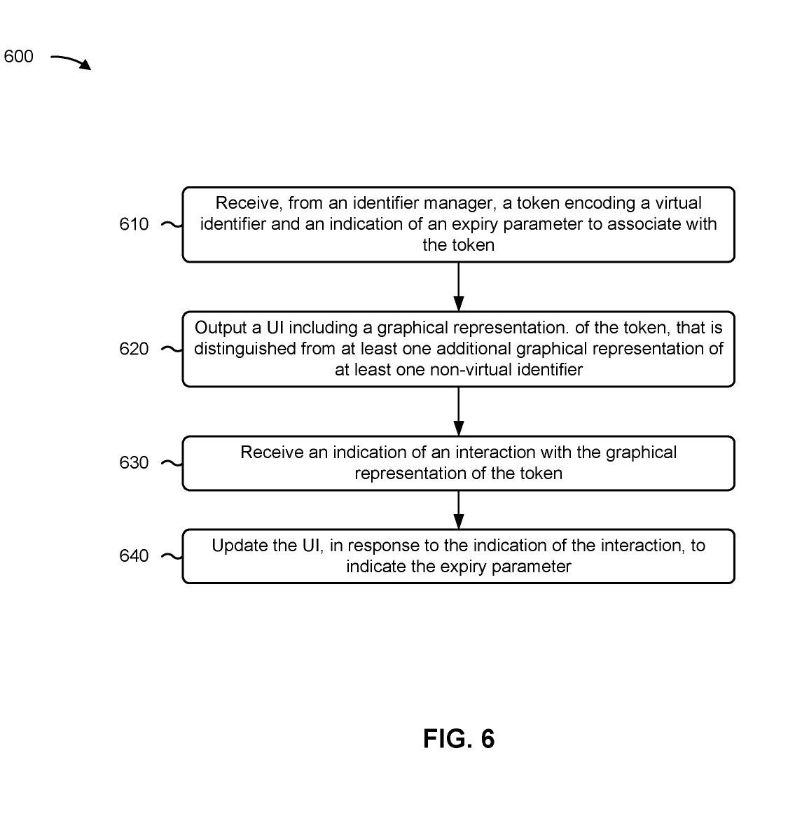

FIG. 6 is a flowchart of an example process 600 associated with receiving virtual identifiers with expiry parameters. In some implementations, one or more process blocks of FIG. 6 may be performed by a mobile receiving device 350. In some implementations, one or more process blocks of FIG. 6 may be performed by another device or a group of devices separate from or including the mobile receiving device 350, such as an identifier manager 301, a user device 330, and/or an account manager 340. Additionally, or alternatively, one or more process blocks of FIG. 6 may be performed by one or more components of the device 400, such as processor 420, memory 430, input component 440, output component 450, and/or communication component 460.

As shown in FIG. 6, process 600 may include receiving, from an identifier manager, a token encoding a virtual identifier and an indication of an expiry parameter to associate with the token (block 610). For example, the mobile receiving device 350 (e.g., using processor 420, memory 430, and/or communication component 460) may receive, from an identifier manager, a token encoding a virtual identifier and an indication of an expiry parameter to associate with the token, as described above in connection with reference number 130 of FIG. 1C. As an example, the mobile receiving device 350 may receive the token and the indication using an application executed by the mobile receiving device 350. The application may include a digital wallet that (securely) stores the token for use in future requests (e.g., for transactions or other events). The mobile receiving device 350 may authenticate itself to the identifier manager in order to receive the token and the indication.

As further shown in FIG. 6, process 600 may include outputting a UI including a graphical representation, of the token, that is distinguished from at least one additional graphical representation of at least one non-virtual identifier (block 620). For example, the mobile receiving device 350 (e.g., using processor 420, memory 430, and/or output component 450) may output a UI including a graphical representation, of the token, that is distinguished from at least one additional graphical representation of at least one non-virtual identifier, as described above in connection with reference number 135 of FIG. 1C. As an example, as described in connection with FIGS. 2A and 2D, the graphical representation may be distinguished by being grouped in a first area of the UI that is separate from a second area of the UI that includes the at least one additional graphical representation. Additionally, or alternatively, as described in connection with FIGS. 2B and 2E, the graphical representation may be distinguished by including a visual indicator that is omitted from the at least one additional graphical representation.

As further shown in FIG. 6, process 600 may include receiving an indication of an interaction with the graphical representation of the token (block 630). For example, the mobile receiving device 350 (e.g., using processor 420, memory 430, and/or input component 440) may receive an indication of an interaction with the graphical representation of the token, as described above in connection with FIG. 1C. As an example, a user of the mobile receiving device 350 may click, tap, and/or use a voice command (e.g., via input component 440) to interact with the graphical representation.

As further shown in FIG. 6, process 600 may include updating the UI, in response to the indication of the interaction, to indicate the expiry parameter (block 640). For example, the mobile receiving device 350 (e.g., using processor 420 and/or memory 430) may update the UI, in response to the indication of the interaction, to indicate the expiry parameter, as described above in connection with FIG. 1C. As an example, the mobile receiving device 350 may update the UI by generating a pop-up window, overlaid on the UI, indicating the expiry parameter, as described in connection with FIG. 2C. Alternatively, the mobile receiving device 350 may update the UI by generating a new screen with information about the token that indicates the expiry parameter, as described in connection with FIG. 2F.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel. The process 600 is an example of one process that may be performed by one or more devices described herein. These one or more devices may perform one or more other processes based on operations described herein, such as the operations described in connection with FIGS. 1A-1E and/or FIGS. 2A-2F. Moreover, while the process 600 has been described in relation to the devices and components of the preceding figures, the process 600 can be performed using alternative, additional, or fewer devices and/or components. Thus, the process 600 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code - it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for providing a virtual identifier, with an expiry parameter, to a mobile receiving device, the system comprising:
one or more memories; and
one or more processors, communicatively coupled to the one or more memories, configured to:
receive, from a user device, a request for the virtual identifier, the request indicating an intended user for the virtual identifier and a permanent identifier to be associated with the virtual identifier;
receive, from the user device, an indication of the expiry parameter for the virtual identifier;
generate the virtual identifier in response to the request;
transmit, to an account manager, the virtual identifier for association with the permanent identifier and the expiry parameter;
determine the mobile receiving device based on the intended user;
transmit, to an application executed by the mobile receiving device, a token encoding the virtual identifier; and
transmit, to the application executed by the mobile receiving device, an indication of the expiry parameter to associate with the token.

2. The system of claim 1, wherein the one or more processors are configured to:
receive, from the mobile receiving device, a set of credentials; and
verify the set of credentials,
wherein the token is transmitted based on verifying the set of credentials.

3. The system of claim 1, wherein the one or more processors, to determine the mobile receiving device, are configured to:
map an indication of the intended user for the virtual identifier, included in the request, to an identifier of the mobile receiving device.

4. The system of claim 1, wherein the one or more processors, to transmit the token encoding the virtual identifier, are configured to:
transmit an encrypted token that authorizes the application executed by the mobile receiving device to use the virtual identifier.

5. The system of claim 1, wherein the expiry parameter includes an expiry datetime, an approved category, an approved merchant, or a maximum amount.

6. The system of claim 1, wherein the one or more processors are configured to:
transmit, to the application executed by the mobile receiving device, a portion of the permanent identifier for outputting to the intended user of the mobile receiving device.

7. The system of claim 1, wherein the one or more processors, to generate the virtual identifier, are configured to:
apply an algorithmic formula to the permanent identifier to obtain the virtual identifier; or
generate, for the virtual identifier, one or more numbers pseudorandomly in combination with one or more fixed numbers of the virtual identifier.

8. A method of receiving a virtual identifier, with an expiry parameter, at a mobile receiving device, comprising:
receiving, at a mobile device and from an identifier manager, a token encoding the virtual identifier and an indication of the expiry parameter to associate with the token;
outputting, by the mobile device, a user interface (UI) including a graphical representation of the token;
determining, by the mobile device and based on the expiry parameter, that the token has expired; and
modifying, by the mobile device, the UI to hide the graphical representation of the token in response to determining that the token has expired.

9. The method of claim 8, further comprising:
transmitting, from the mobile device and to the identifier manager, a set of credentials,
wherein the token is received in response to the set of credentials.

10. The method of claim 8, wherein determining that the token has expired comprises:
determining that a datetime, indicated by the expiry parameter, has passed.

11. The method of claim 8, wherein determining that the token has expired comprises:
tracking one or more transactions performed using the token; and
determining that the one or more transactions satisfy a transaction threshold indicated by the expiry parameter.

12. The method of claim 8, wherein determining that the token has expired comprises:
tracking one or more transactions performed using the token; and
determining that a total amount of the one or more transactions satisfy a spend threshold indicated by the expiry parameter.

13. The method of claim 8, wherein modifying the UI comprises:
removing the graphical representation from the UI altogether.

14. The method of claim 8, wherein modifying the UI comprises:
moving the graphical representation of the token to a hidden section of the UI accessible via an interaction with the UI.

15. A non-transitory computer-readable medium storing a set of instructions for receiving a virtual identifier with an expiry parameter, the set of instructions comprising:
one or more instructions that, when executed by one or more processors of a device, cause the device to:
receive, from an identifier manager, a token encoding the virtual identifier and an indication of the expiry parameter to associate with the token;
output a user interface (UI) including a graphical representation of the token, wherein the graphical representation is distinguished from at least one additional graphical representation of at least one non-virtual identifier;
receive an indication of an interaction with the graphical representation of the token; and
update the UI, in response to the indication of the interaction, to indicate the expiry parameter.

16. The non-transitory computer-readable medium of claim 15, wherein the one or more instructions, when executed by the one or more processors, cause the device to:
determine based on the expiry parameter, that the token has expired; and
modify the UI to hide the graphical representation of the token in response to determining that the token has expired.

17. The non-transitory computer-readable medium of claim 15, wherein the graphical representation is distinguished, from the at least one additional graphical representation of the at least one non-virtual identifier, by being grouped in a first area of the UI that is separate from a second area of the UI that includes the at least one additional graphical representation.

18. The non-transitory computer-readable medium of claim 15, wherein the graphical representation is distinguished, from the at least one additional graphical representation of the at least one non-virtual identifier, by including a visual indicator that is omitted from the at least one additional graphical representation.

19. The non-transitory computer-readable medium of claim 15, wherein the one or more instructions, that cause the device to update the UI to indicate the expiry parameter, cause the device to:
generate a pop-up window, overlaid on the UI, indicating the expiry parameter.

20. The non-transitory computer-readable medium of claim 15, wherein the one or more instructions, that cause the device to update the UI to indicate the expiry parameter, cause the device to:
generate a new screen including information about the token, wherein the information indicates the expiry parameter.
